(19) United States
(12) Patent Application Publication
(10) Pub. No.: US 2026/0159751 A1
(43) Pub. Date: Jun. 11, 2026

(54) ENHANCED OIL RECOVERY FROM SUBSURFACE RESERVOIRS

(71) Applicant: King Fahd University of Petroleum and Minerals, Dhahran (SA)

(72) Inventors: Mohammed ALYOUSEF, Dhahran (SA); Muhammad Shahzad KAMAL, Dhahran (SA); Mobeen MURTAZA, Dhahran (SA); Ridha AL-ABDRABALNABI, Dhahran (SA)

(73) Assignee: King Fahd University of Petroleum and Minerals, Dhahran (SA)

(21) Appl. No.: 19/182,368

(22) Filed: Apr. 17, 2025

Related U.S. Application Data
(60) Provisional application No. 63/662,213, filed on Jun. 20, 2024.

(51) Int. Cl. C09K 8/60; E21B 43/16

(52) U.S. Cl. CPC C09K 8/602; E21B 43/16; C09K 2208/10

(57) ABSTRACT

A method of enhanced oil recovery (EOR) includes injecting a surfactant fluid, through a borehole, into a subterranean hydrocarbon-bearing geological formation having a first production rate. The surfactant fluid includes 0.01 to 1.0 percent by weight (wt. %) sodium dodecyl sulfate, 0.005 to 0.4 wt. % silicon dioxide (SiO₂) nanoparticles (NPs), and a brine solution with 55,000 to 60,000 parts per million (ppm) salt concentration based on a total weight of the surfactant fluid. The SiO₂ NPs have a longest dimension of 10 to 20 nanometers (nm). The method further includes recovering one or more hydrocarbons from the subterranean hydrocarbon-bearing geological formation at a second production rate that is greater than the first production rate. The surfactant fluid does not form a scale or precipitate after 24 hours exposure to the subterranean hydrocarbon-bearing geological formation at a temperature of 70 degrees Celsius (° C.) or greater.

### CROSS REFERENCE TO RELATED APPLICATION

This application claims the benefit of U.S. Provisional Application No. 63/662,213, filed Jun. 20, 2024, which is incorporated herein by reference in its entirety.

### BACKGROUND

### Technical Field

The present disclosure is directed towards enhanced oil recovery (EOR) techniques, and more particularly, relates to a method for recovering oil from a subterranean hydrocarbon-bearing geological formation.

### Description of Related Art

The “background” description provided herein is to present the context of the disclosure generally. Work of the presently named inventors, to the extent it is described in this background section, as well as aspects of the description that may not otherwise qualify as prior art at the time of filing, are neither expressly nor impliedly admitted as prior art against the present disclosure.

Oil production occurs in three phases: primary, secondary, and tertiary recovery. Primary recovery relies on natural reservoir pressure or artificial lift devices like pumps. Secondary recovery involves water or gas injections to push oil to the surface. Despite these methods, up to 75% of crude oil often remains trapped in reservoirs. Tertiary recovery, known as enhanced oil recovery (EOR), increases extraction efficiency by utilizing advanced techniques, including surfactants. Surfactants play a role in enhanced oil recovery due to their ability to accumulate at interfaces and modify solution properties. Widely used in detergents, medical formulations, and anti-corrosive treatments [Vaisman, L. et al., The role of surfactants in dispersion of carbon nanotubes, Adv Colloid Interface Sci, 2006, 128-130, 37-46], surfactants were used for EOR applications, improving extraction efficiency and extending the lifespan of oil reservoirs [Massarweh, O. et al., The use of surfactants in enhanced oil recovery: A review of recent advances, Energy Reports, 2020, 6, 3150-3178].

EOR methods, including thermal, chemical, miscible, and biotechnological techniques, which may enhance recovery by improving oil displacement and restoring reservoir pressure remain an area to be explored. Although effective, EOR techniques present several challenges. Thermal methods, such as steam injection and in-situ combustion, suffer from heat loss in deep reservoirs, early steam breakthrough, and poor process control, reducing sweep efficiency. Gas injection methods, especially carbon dioxide (CO₂) flooding, face limitations due to high operational costs, complex infrastructure, and the need for precise pressure control. Chemical methods, including surfactant and polymer flooding, encounter issues like chemical degradation, adsorption onto reservoir rocks, and reduced effectiveness in high-salinity environments. These drawbacks increase operational complexity and costs, driving the search for more efficient and sustainable recovery alternatives.

Anionic surfactants, particularly petroleum sulfonates, are the most widely used in EOR applications [Kamal, M. S. et al., Review on surfactant flooding: phase behavior, retention, IFT, and field applications, Energy & Fuels, 2017, 31, 8]. They play a role in reducing interfacial tension (IFT) and altering reservoir rock wettability [Sircar, S. et al., Applications of nanoparticles in enhanced oil recovery, Petroleum Research, 2022, 7, 1, 77-90]. Despite their effectiveness, anionic surfactants face challenges in high-salinity environments. Petroleum sulfonates, known for their good interfacial properties which exhibit poor salt resistance, leading to severe precipitation under such conditions [Xiao, Z. et al., Synergistic effects of surfactants on depressurization and augmented injection in high salinity low-permeability reservoirs: Formula development and mechanism study, Colloids Surf A Physicochem Eng Asp, 2021, 628, 9, 127312]. Poor aqueous stability in high-salinity solutions limits the applicability of commercially available anionic surfactants for EOR applications. Utilization of nonionic surfactants with anionic surfactants has been proposed as a solution to address the issue. Nonionic surfactants serve as co-surfactants, enhancing the efficacy of anionic surfactants [Belhaj, A. F. et al., The effect of surfactant concentration, salinity, temperature, and pH on surfactant adsorption for chemical enhanced oil recovery: a review, J Pet Explor Prod Technol, 2020, 10, 125-137]. Particularly valuable in environments with high salinity, nonionic surfactants improve the aqueous stability of anionic surfactants [Sheng, J. J., Surfactant flooding, in Modern chemical enhanced oil recovery: theory and practice, Elsevier, 2011]. Several challenges exist in incorporating nonionic surfactants with anionic surfactants including compatibility issues between nonionic and anionic surfactants. Furthermore, economic feasibility of integrating nonionic surfactants into anionic formulations may vary and may be influenced by factors such as the quantity and performance of the surfactants.

Nanoparticles (NPs), particularly silicon dioxide (SiO₂) NPs, have emerged as a promising strategy to enhance surfactant performance in EOR applications [Tavakkoli, O. et al., Effect of nanoparticles on the performance of polymer/surfactant flooding for enhanced oil recovery: A review, Fuel, 2022, 312, 122867]. Their stability and dispersibility under harsh conditions present challenges. The stability of SiO₂ NPs is improved by incorporating surfactants, especially anionic surfactants, which prevent NP aggregation through the creation of repulsive forces between surfactant molecules and NPs, maintaining dispersion [Bai, Y. et al., Performance evaluation and mechanism study of a functionalized silica nanofluid for enhanced oil recovery in carbonate reservoirs, Colloids Surf A Physicochem Eng Asp, 2022, 652, 129939]. SiO₂ NPs are often combined with surfactants to form nanofluids, which shows potential for future EOR applications and have attracted scientific interest. These nanofluids reduce interfacial tension (IFT) and promote spontaneous emulsion formation, facilitating better oil displacement [Mohajeri, M. et al., Experimental study on using SiO₂ nanoparticles along with surfactant in an EOR process in micromodel, Petroleum Research, 2019, 4, 1, 59-70]. Aqueous dispersions of SiO₂ NPs (<100 nanometer (nm) diameter) alter wettability in rock/fluid and fluid/fluid interactions which enhances oil recovery [Amrouche, F. et al., New insights into application of nanoparticles for water-based enhanced oil recovery in carbonate reservoirs, Colloids Surf A Physicochem Eng Asp, 2019, 33, 11].

Recent advancements in oil recovery have improved extraction efficiency for heavy crude oils, yet challenges remain, including the risk of reservoir fracturing during high-pressure CO₂ injection, economic feasibility concerns with steam injection, temperature control, and environmental issues. SiO₂ nanoparticles (NPs) and surfactants have been used at room temperature, neglecting the effects of harsh temperature conditions that lead to surfactant or NP degradation [Ramezani, M. et al., Experimental study about the effect of SiO₂ nanoparticle in surfactant performance on IFT reduction and wettability alteration, Chemical Engineering Research and Design, 2023, 192, 350-361]. Despite efforts to enhance oil recovery, previous work on SiO₂ nanofluids aimed to improve surfactant performance while overlooking the enhancement of aqueous stability in anionic surfactants. Much work utilized deionized or low-salinity water as base fluids, which is impractical for field applications as seawater is commonly used. SiO₂ nanofluids, under real-world conditions, need to be developed more efficiently and sustainably, to lead to cost-effective oil recovery methods.

Accordingly, an object of the present disclosure is to provide a method of enhanced oil recovery (EOR) in a subterranean geological formation to improve oil recovery, that may circumvent the drawbacks and limitations, such as, high operating pressures, insufficient miscibility, asphaltene precipitation, and excessive gas consumption, of the methods known in the art.

### SUMMARY

In an exemplary embodiment, a method of enhanced oil recovery (EOR) is described. The method includes injecting a surfactant fluid, through a borehole, into a subterranean hydrocarbon-bearing geological formation having a first production rate. The surfactant fluid includes sodium dodecyl sulfate (SDS) in an amount of 0.01 to 1.0 percent by weight (wt. %), silicon dioxide (SiO₂) nanoparticles (NPs) in an amount of 0.005 to 0.4 wt. %, and a brine solution with a salt concentration of 55,000 to 60,000 parts per million (ppm). Wt. % is based on a total weight of the surfactant fluid. The SiO₂ NPs have a longest dimension of 10 to 20 nanometers (nm). The brine solution includes sodium bicarbonate (NaHCO₃), sodium sulfate (Na₂SO₄), sodium chloride (NaCl), calcium chloride (CaCl₂)), and magnesium chloride (MgCl₂). The method further includes recovering one or more hydrocarbons from the subterranean hydrocarbon-bearing geological formation at a second production rate that is greater than the first production rate. The surfactant fluid does not form a scale or precipitate after 24 hours (h) exposure to the subterranean hydrocarbon-bearing geological formation at a temperature of 70 degree Celsius (° C.) or greater.

In some embodiments, the brine solution has a salt concentration of 56,000 to 58,000 ppm.

In some embodiments, the brine solution has a salt concentration of 57,700 to 57,800 ppm.

In some embodiments, the temperature of the subterranean hydrocarbon-bearing geological formation is at least 75° C.

In some embodiments, the surfactant fluid has a zeta potential of −30 to −25 millivolts (mV).

In some embodiments, the method further includes mixing the surfactant fluid for 2 minutes (min) to 30 min, then settling the surfactant fluid for 6 h to 12 h, then stirring the surfactant fluid for 30 min to 90 min, and then sonicating the surfactant fluid for 20 min to 60 min before the injecting.

In some embodiments, the sodium bicarbonate has a concentration of 150 to 180 ppm in the brine solution.

In some embodiments, the sodium sulfate has a concentration of 6300 to 6380 ppm in the brine solution.

In some embodiments, the sodium chloride has a concentration of 41,100 to 41,300 ppm in the brine solution.

In some embodiments, the calcium chloride has a concentration of 1700 to 1900 ppm in the brine solution.

In some embodiments, the magnesium chloride has a concentration of 8200 to 8300 ppm in the brine solution.

In some embodiments, the SDS is present in an amount of 0.4 to 0.6 wt. % based on a total weight of the surfactant fluid.

In some embodiments, the SiO₂ NPs are present in an amount of 0.05 to 0.3 wt. % based on a total weight of the surfactant fluid.

In some embodiments, the SiO₂ NPs are present in an amount of 0.008 to 0.012 wt. % based on a total weight of the surfactant fluid.

In some embodiments, the method further includes circulating the surfactant solution in the borehole at a temperature of 65 to 75° C.

In some embodiments, the method further includes circulating the surfactant solution in the borehole at a temperature of 20 to 30° C.

In some embodiments, the surfactant fluid has an electrophoretic mobility of −2 to −2.4 micrometer centimeter per volt-second (μm·cm/Vs).

In some embodiments, the surfactant fluid has an electrophoretic mobility of −2.1 to −2.3 μm·cm/Vs.

In some embodiments, the method includes a rate of recovering one or more hydrocarbons from the subterranean hydrocarbon-bearing geological formation with the surfactant fluid that is greater than a rate of recovering one or more hydrocarbons from the subterranean hydrocarbon-bearing geological formation with water.

In some embodiments, the surfactant fluid has a zeta potential of −29 to −27 mV.

In some embodiments, the surfactant fluid has a conductivity of 69 to 70 millisiemens per centimeter (mS/cm).

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic flow chart depicting a method of enhanced oil recovery (EOR), according to certain embodiments.

FIG. 2 depicts chemical structures of sodium dodecyl sulfate (SDS) and silicon dioxide (SiO₂), according to certain embodiments.

FIG. 3 is an image depicting different SiO₂ NP concentrations, including 0.01 weight percent (wt. %), 0.1 wt. % and 0.5 wt. %, with SDS, according to certain embodiments.

FIG. 4A is an image of formulations of deionized water (DIW)+SiO₂ NPs, seawater (SW)+SiO₂ NPs, SDS in SW, and SDS in SW+SiO₂ NPs on day one at 25 degrees Celsius (° C.), according to certain embodiments.

FIG. 4B is an image of formulations of DIW+SiO₂ NPs, SW+SiO₂ NPs, SDS in SW, and SDS in SW+SiO₂ NPs on day seven at 25° C., according to certain embodiments.

FIG. 4C is an image of formulations of DIW+SiO₂ NPs, SW+SiO₂ NPs, SDS in SW, and SDS in SW+SiO₂ NPs on day one at 70° C., according to certain embodiments.

FIG. 4D is an image of formulations of DIW+SiO₂ NPs, SW+SiO₂ NPs, SDS in SW, and SDS in SW+SiO₂ NPs on day seven at 70° C., according to certain embodiments.

FIG. 5A is an image of SDS in seawater (SW) on day one at 25° C., according to certain embodiments.

FIG. 5B is an image of SDS in SW on day seven at 25° C., according to certain embodiments.

FIG. 5C is an image of SDS in SW+SiO₂ nanoparticles (NPs) on day one at 25° C., according to certain embodiments.

FIG. 5D is an image of SDS in SW+SiO₂ nanoparticles on day seven at 25° C., according to certain embodiments.

FIG. 5E is an image of SDS in SW on day one at 70° C., according to certain embodiments.

FIG. 5F is an image of SDS in SW on day seven at 70° C., according to certain embodiments.

FIG. 5G is an image of SDS in SW+SiO₂ nanoparticles on day one at 70° C., according to certain embodiments.

FIG. 5H is an image of SDS in SW+SiO₂ nanoparticles on day seven at 70° C., according to certain embodiments.

FIG. 6A is a transmission profile of SDS in SW+SiO₂ NPs after one day at 70° C., according to certain embodiments.

FIG. 6B is a transmission profile of DIW+SiO₂ NPs after one day at 70° C., according to certain embodiments.

FIG. 6C is a transmission profile of SDS in SW after one day at 70° C., according to certain embodiments.

FIG. 6D is a transmission profile of SW+SiO₂ NPs after one day at 70° C., according to certain embodiments, according to certain embodiments.

FIG. 7 is a graph of transmission stability index (SI) versus time, according to certain embodiments.

FIG. 8 depicts rate of phase separation versus time, according to certain embodiments.

FIG. 9 depicts measured and predicted rates of phase separation versus time for seven days, according to certain embodiments.

FIG. 10 depicts separability number of SDS in SW+SiO₂ NPs, DIW+SiO₂ NPs, SDS in SW, and SW+SiO₂ NPs formulations, according to certain embodiments.

FIG. 11 is a bar graph of zeta potential (ZP) values of SDS in SW+SiO₂ NPs, DIW+SiO₂ NPs, SDS in SW, and SW+SiO₂ NPs formulations versus time, according to certain embodiments.

FIG. 12A depicts an initial high-definition distribution (HDD) profile of SDS in SW+SiO₂ NPs, according to certain embodiments.

FIG. 12B is an initial HDD profile of SDS in SW, according to certain embodiments.

FIG. 12C is an initial HDD profile of SW+SiO₂ NPs, according to certain embodiments.

FIG. 12D is an initial HDD profile of DIW+SiO₂ NPs, according to certain embodiments.

FIG. 13 is a bar graph of HDD values of SDS in SW+SiO₂ NPs, DIW+SiO₂ NPs, SDS in SW, and SW+SiO₂ NPs solutions at seven days, according to certain embodiments.

FIG. 14 is a plot of zeta potential measurements for SDS and SDS in SW+SiO₂ NPs, according to certain embodiments.

FIG. 15 is a transmission profile of SDS in SW+SiO₂ NPs, according to certain embodiments.

### DETAILED DESCRIPTION

When describing the present disclosure, the terms used are to be construed in accordance with the following definitions, unless a context dictates otherwise.

Embodiments of the present invention will now be described more fully hereinafter with reference to the accompanying drawings wherever applicable, in that some, but not all, embodiments of the disclosure are shown.

In the drawings, like reference numerals designate identical or corresponding parts throughout the several views. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

A weight percent of a component, unless specifically stated to the contrary, is based on the total weight of the formulation or composition in which the component is included. For example, if a particular element or component in a composition or article is said to have 5 weight percent (wt. %), it is understood that this percentage is in relation to a total compositional percentage of 100%.

The present disclosure is intended to include all hydration states of a given compound or formula, unless otherwise noted or when heating a material.

In addition, the present disclosure is intended to include all isotopes of atoms occurring in the present compounds and complexes. Isotopes include those atoms having the same atomic number but different mass numbers. By way of general example, and without limitation, isotopes of hydrogen include deuterium and tritium, and isotopes of carbon include ¹³C and ¹⁴C. Isotopically-labelled compounds of the disclosure may generally be prepared by conventional techniques known to those skilled in the art or by processes analogous to those described herein, using an appropriate isotopically-labelled reagent in place of the non-labelled reagent otherwise employed.

As used herein, the term “surfactant” refers to a compound that lowers the surface tension (or interfacial tension) between two liquids, between a liquid and a gas, or between a liquid and a solid. The surfactant may also be a gemini surfactant. A “gemini surfactant,” also known as a “dimeric surfactant,” as used herein, refers to two surfactant molecules bonded together by a spacer. The surfactant may serve a role as a water-wetting agent, a defoamer, a foamer, a detergent, a dispersant, or an emulsifier.

A surfactant molecule includes one or more hydrophilic head units attached to one or more hydrophobic tails. The tail of most surfactants includes a hydrocarbon chain, which can be branched, linear, or aromatic. Fluorosurfactants have fluorocarbon chains. Siloxane surfactants have siloxane chains. Gemini surfactant molecules include two or more hydrophilic heads and two or more hydrophobic tails. Many surfactants include a polyether chain terminating in a highly polar anionic group. The polyether groups often include ethoxylated (polyethylene oxide-like) sequences inserted to increase the hydrophilic character of a surfactant. Alternatively, polypropylene oxides may be inserted to increase the lipophilic character of a surfactant.

Cationic surfactants have cationic functional groups at their head, such as primary and secondary amines. Cationic surfactants include, but are not limited to, octenidine dihydrochloride, cetrimonium bromide (CTAB), cetylpyridinium chloride (CPC), benzalkonium chloride (BAC), benzethonium chloride (BZT), dimethyldioctadecylammonium chloride, dioctadecyldimethylammonium bromide (DODAB), a combination thereof, and the like. A cationic surfactant may be replaced by a nonionic surfactant, an anionic surfactant, a cationic surfactant, a viscoelastic surfactant, a zwitterionic surfactant, a combination thereof, and the like.

Anionic surfactants contain anionic functional groups at their head, such as sulfate, sulfonate, phosphate, carboxylate, and the like. The anionic surfactant may be an alkyl sulfate, an alkyl ether sulfate, an alkyl ester sulfonate, an alpha olefin sulfonate, a linear alkyl benzene sulfonate, a branched alkyl benzene sulfonate, a linear dodecylbenzene sulfonate, a branched dodecylbenzene sulfonate, an alkyl benzene sulfonic acid, a dodecylbenzene sulfonic acid, a sulfosuccinate, a sulfated alcohol, a ethoxylated sulfated alcohol, an alcohol sulfonate, an ethoxylated and propoxylated alcohol sulfonate, an alcohol ether sulfate, an ethoxylated alcohol ether sulfate, a propoxylated alcohol sulfonate, a sulfated nonyl phenol, an ethoxylated and propoxylated sulfated nonyl phenol, a sulfated octyl phenol, an ethoxylated and propoxylated sulfated octyl phenol, a sulfated dodecyl phenol, and an ethoxylated and propoxylated sulfated dodecyl phenol, and combination thereof, and the like. Other anionic surfactants include, but are not limited to, ammonium lauryl sulfate, sodium lauryl sulfate (sodium dodecyl sulfate, SLS, or SDS), and related alkyl-ether sulfates sodium laureth sulfate (sodium lauryl ether sulfate or SLES), sodium myreth sulfate, docusate (dioctyl sodium sulfosuccinate), perfluorooctanesulfonate (PFOS), perfluorobutanesulfonate, alkyl-aryl ether phosphates, alkyl ether phosphates, a combination thereof, and the like.

Zwitterionic (amphoteric) surfactants have both cationic and anionic groups attached to the same molecule. The zwitterionic surfactants include, but are not limited to, CHAPS (3-[(3-cholamidopropyl)dimethylammonio]-1-propanesulfonate), cocamidopropyl hydroxysultaine, ocamidopropyl betaine, phospholipids, sphingomyelins, a combination thereof, and the like.

Nonionic surfactants have a polar group that does not have a charge. These include long chain alcohols that exhibit surfactant properties, such as cetyl alcohol, stearyl alcohol, cetostearyl alcohol, oleyl alcohol, and other fatty alcohols. Other long chain alcohols with surfactant properties include, but are not limited to, polyethylene glycols of various molecular weights, polyethylene glycol alkyl ethers having the formula CH₃ (CH₂)₁₀₋₁₆ (OC₂H₄)₁₋₂₅OH, such as octaethylene glycol monododecyl ether and pentaethylene glycol monododecyl ether; polypropylene glycol alkyl ethers having the formula CH₃ (CH₂)₁₀₋₁₆ (OC₃H₆)₁₋₂₅OH; glucoside alkyl ethers having the formula CH₃ (CH₂)₁₀₋₁₆ (O-glucoside)₁₋₃OH, such as decyl glucoside, lauryl glucoside, octyl glucoside; polyethylene glycol octylphenyl ethers having the formula C₈H₁₇C₆H₄ (OC₂H₄)₁₋₂₅OH, such as Triton X-100; polyethylene glycol alkylphenyl ethers having the formula C₉H₁₉C₆H₄ (OC₂H₄)₁₋₂₅—OH, such as nonoxynol-9; glycerol alkyl esters such as glyceryl laurate; polyoxyethylene glycol sorbitan alkyl esters such as polysorbate, sorbitan alkyl esters, cocamide MEA, cocamide DEA, dodecyldimethylamine oxide, block copolymers of polyethylene glycol and polypropylene glycol, such as poloxamers, polyethoxylated tallow amine (POEA), a combination thereof, and the like.

A dendritic surfactant molecule may include at least two lipophilic chains that have been joined at a hydrophilic center and have a branch-like appearance. In each dendritic surfactant, there may be from about 2 lipophilic moieties independently to about 4 lipophilic moieties attached to each hydrophilic group, or up to about 8 lipophilic moieties attached to the hydrophilic group for example. “Independently,” as used herein, with respect to ranges means that any lower threshold may be combined with any upper threshold. The dendritic surfactant may have better repulsion effect as a stabilizer at an interface and/or better interaction with a polar oil, as compared with other surfactants. Dendritic surfactant molecules are sometimes called “hyperbranched” molecules.

A dendritic extended surfactant is a dendritic surfactant having a non-ionic spacer arm between the hydrophilic group and a lipophilic tail. For example, the non-ionic spacer-arm extension may be the result of polypropoxylation, polyethoxylation, or a combination of the two with the polypropylene oxide next to the tail and polyethylene oxide next to the head. The spacer arm of a dendritic extended surfactant may contain from about 1 independently to about 20 propoxy moieties and/or from about 0 independently to about 20 ethoxy moieties. Alternatively, the spacer arm may contain from about 2 independently up to about 16 propoxy moieties and/or from about 2 independently up to about 8 ethoxy moieties. The spacer arm extensions may also be formed from other moieties including, but not necessarily limited to, glyceryl, butoxy, glucoside, isosorbide, xylitols, a combination thereof, and the like. For example, the spacer arm of a dendritic extended surfactant may contain both propoxy and ethoxy moieties. The polypropoxy portion of the spacer arm may be considered lipophilic; however, the spacer arm may also contain a hydrophilic portion to attach the hydrophilic group. The hydrophilic group may generally be a polyethoxy portion having about two or more ethoxy groups. These portions are generally in blocks, rather than being randomly mixed. Further, the spacer arm extension may be a polypropylene oxide chain.

As used herein, the term “zeta potential” refers to the electrical potential difference between a particle's surface and the surrounding liquid. It measures the stability of colloidal suspensions, with a high zeta potential indicating good stability (strong repulsion between particles) and a low zeta potential indicating potential instability (weak repulsion and possible aggregation).

As used herein, the term “electrophoretic mobility” refers to a rate at which a particle moves in an electric field divided by the strength of the field. It is a measure of how easily a particle moves in response to an applied electric potential. This property depends on factors like the particle's size, charge, and the medium's viscosity. Electrophoretic mobility is often used to study colloidal particles, nanoparticles, and other charged systems.

As used herein, the term “brine solution” refers to an aqueous solution containing dissolved salts, where the concentration of dissolved salts is sufficiently high to achieve properties such as increased ionic strength, enhanced solubility of gases (such as CO₂), or to facilitate specific chemical reactions.

As used herein, the term “room temperature” refers to a temperature range of 25±3 degrees Celsius (° C.) in the present disclosure.

As used herein, the term “subterranean geological formation” refers to a large-scale feature that exists beneath the Earth's surface.

As used herein, the term “electrical conductivity” refers to the capability of a material to pass the flow of electric current. Electrical conductivity differs from one material to another depending on the ability to let electricity flow.

As used herein, the term “hydrocarbon” refers to a chemical compound composed of hydrogen and carbon atoms. Hydrocarbons can be found in various forms, including alkanes, alkenes, alkynes, and aromatic hydrocarbons. Hydrocarbons can be either saturated (containing only single bonds between carbon atoms) or unsaturated (containing one or more double or triple bonds).

As used herein, the term “enhanced oil recovery (EOR)” refers to a method or a set of methods used to extract more oil from an oil reservoir after primary and secondary recovery techniques have been exhausted. The methods generally involve injecting substances such as water, gas, or chemicals into the reservoir to increase pressure, reduce oil viscosity, and/or improve the flow of oil to the surface, thereby boosting production.

Aspects of the present disclosure are directed to a method of enhanced oil recovery (EOR) including injecting an aqueous solution of anionic surfactants, such as SDS, in high-salinity environments. The method involves incorporating silicon dioxide (SiO₂), also referred to as silica, nanoparticles (MPs) into surfactant solutions to improve stability by preventing precipitation and scaling. The presence of silica nanoparticles enhances electrostatic repulsion between surfactant molecules, promoting better dispersion and long-term stability. The present disclosure provides a cost-effective, environmentally sustainable solution for improving EOR efficiency.

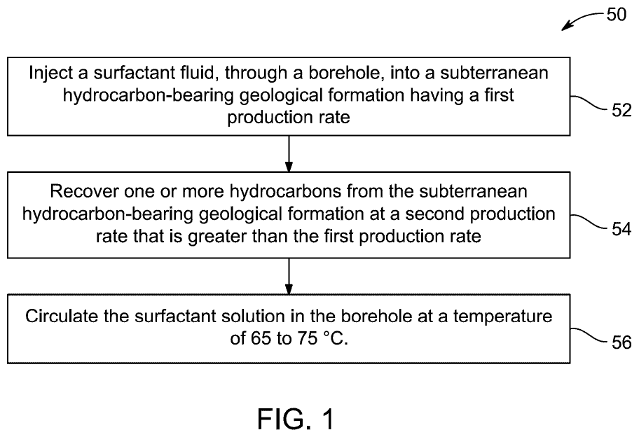

FIG. 1A illustrates a schematic flow chart of a method 50 of enhanced oil recovery (EOR). The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes injecting a surfactant fluid, through a borehole, into a subterranean hydrocarbon-bearing geological formation having a first production rate. Examples of subterranean hydrocarbon-bearing geological formations may include, but are not limited to, oil sands (tar sands), shale oil formations, sandstone reservoirs, limestone reservoirs, coalbed methane (CBM), tight oil formations, a combination thereof, and the like. In one or more embodiments, the borehole may be present in an oil well, a gas well, a production well, an injection well, a naturally flowing well, an artificially lifted well, a high-temperature well, a steam-assisted gravity drainage well, a steam injector well, a geothermal well, a combination thereof, and the like. The borehole may be formed in the subterranean hydrocarbon-bearing geologic formation by known techniques.

The surfactant fluid includes sodium dodecyl sulfate (SDS) in an amount of 0.01 to 1.0 precent by weight (wt. %), preferably 0.1 to 0.9 wt. %, preferably 0.2 to 0.8 wt. %, preferably 0.3 to 0.7 wt. %, preferably 0.4 to 0.6 wt. %, and preferably about 0.5 wt. % based on a total weight of the surfactant fluid. In some embodiments, the SDS is present in an amount of 0.4 to 0.6 wt. %, preferably 0.41 to 0.59 wt. %, preferably 0.42 to 0.58 wt. %, preferably 0.43 to 0.57 wt. %, preferably 0.44 to 0.56 wt. %, preferably 0.45 to 0.55 wt. %, preferably 0.46 to 0.54 wt. %, preferably 0.47 to 0.53 wt. %, preferably 0.48 to 0.52 wt. %, more preferably 0.49 to 0.51 wt. %, and yet more preferably about 0.5 wt. % based on a total weight of the surfactant fluid. In a preferred embodiment, the SDS is present in an amount of 0.5 wt. % based on a total weight of the surfactant fluid. In other embodiments, the SDS is present in an amount of about 0.01 wt. % based on a total weight of the surfactant fluid. In another embodiment, the SDS is present in an amount of about 0.25 wt. % based on a total weight of the surfactant fluid.

The surfactant fluid includes silicon dioxide nanoparticles (SiO₂ NPs) in an amount of 0.005 to 0.4 percent by weight (wt. %), preferably 0.01 to 0.3 wt. %, preferably 0.05 to 0.25 wt. %, preferably 0.1 to 0.2 wt. %, and preferably 0.13 to 0.17 wt. % based on the total weight of the surfactant fluid. In some embodiments, the SiO₂ NPs are present in an amount of 0.05 to 0.3 wt. %, preferably 0.1 to 0.29 wt. %, preferably 0.15 to 0.28 wt. %, preferably 0.2 to 0.27 wt. %, more preferably 0.24 to 0.26 wt. %, and yet more preferably about 0.25 wt. % based on a total weight of the surfactant fluid. In some embodiments, the SiO₂ NPs are present in an amount of 0.008 to 0.012 wt. %, preferably 0.009 to 0.011 wt. %, and more preferably about 0.01 wt. % based on a total weight of the surfactant fluid. The SiO₂ NPs have a longest dimension of 10 to 20 nanometers (nm), preferably 11 to 19 nm, preferably 12 to 18 nm, preferably 13 to 17 nm, preferably 14 to 16 nm, and preferably about 15 nm.

The surfactant fluid includes a brine solution with a salt concentration of 55,000 to 60,000 parts per million (ppm), preferably 55,500 to 59,000 ppm, preferably 56,000 to 58,000 ppm, preferably 57,000 to 57,900 ppm, preferably 57,700 to 57,800 ppm, preferably 57,720 to 57,780 ppm, more preferably 57,740 to 57,750 ppm, and yet more preferably about 57,745.08 ppm. Suitable examples of salts in the brine solution may include, but are not limited to, sodium chloride, sodium bicarbonate, sodium sulfate, magnesium chloride, potassium chloride, potassium sulfate, potassium bicarbonate, calcium sulfate, calcium nitrate, magnesium sulfate, magnesium nitrate, magnesium acetate, sodium carbonate, disodium hydrogen phosphate, sodium nitrate, potassium bicarbonate, magnesium bicarbonate, iron (II) chloride, iron (III) chloride, iron (II) sulfate, potassium sulfate, barium sulfate, lithium chloride, lithium sulfate, lithium nitrate, calcium chloride, a combination thereof, and the like. The brine solution includes sodium bicarbonate, sodium sulfate, sodium chloride, calcium chloride, and magnesium chloride.

In some embodiments, the sodium bicarbonate has a concentration of 150 to 180 ppm, preferably 151 to 179 ppm, preferably 152 to 178 ppm, preferably 153 to 177 ppm, preferably 154 to 176 ppm, preferably 155 to 175 ppm, preferably 156 to 174 ppm, preferably 157 to 173 ppm, preferably 158 to 172 ppm, preferably 159 to 171 ppm, preferably 160 to 170 ppm, preferably 161 to 169 ppm, preferably 162 to 168 ppm, preferably 163 to 167 ppm, more preferably 164 to 166 ppm, and yet more preferably about 165.24 ppm in the brine solution. In some embodiments, the sodium sulfate has a concentration of 6300 to 6380 ppm, preferably 6305 to 6375 ppm, preferably 6310 to 6370 ppm, preferably 6315 to 6365 ppm, preferably 6320 to 6360 ppm, preferably 6325 to 6355 ppm, preferably 6330 to 6350 ppm, preferably 6335 to 6345 ppm, preferably 6336 to 6344 ppm, preferably 6337 to 6343 ppm, preferably 6338 to 6341 ppm, more preferably 6339 to 6340 ppm, and yet more preferably about 6339.02 ppm in the brine solution. In some embodiments, the sodium chloride has a concentration of 41,100 to 41,300 ppm, preferably 41,105 to 41,290 ppm, preferably 41,110 to 41,280 ppm, preferably 41,115 to 41,250 ppm, preferably 41,120 to 41,240 ppm, preferably 41,130 to 41,230 ppm, preferably 41,140 to 41,220 ppm, preferably 41,150 to 41,210 ppm, preferably 41,160 to 41,200 ppm, more preferably 41,170 to 41,175 ppm, and yet more preferably about 41172.35 ppm in the brine solution. In some embodiments, the calcium chloride has a concentration of 1700 to 1900 ppm, preferably 1710 to 1890 ppm, preferably 1720 to 1880 ppm, preferably 1730 to 1870 ppm, preferably 1740 to 1860 ppm, preferably 1750 to 1850 ppm, preferably 1760 to 1840 ppm, preferably 1770 to 1830 ppm, preferably 1780 to 1820 ppm, preferably 1790 to 1810 ppm, more preferably 1795 to 1805 ppm, and yet more preferably about 1802.12 ppm in the brine solution. In some embodiments, the magnesium chloride has a concentration of 8200 to 8300 ppm, preferably 8210 to 8295 ppm, preferably 8220 to 8290 ppm, preferably 8230 to 8285 ppm, preferably 8240 to 8280 ppm, preferably 8250 to 8275 ppm, preferably 8260 to 8270 ppm, more preferably 8263 to 8268 ppm, and yet more preferably about 8266.3 ppm in the brine solution.

At step 54, the method 50 includes recovering one or more hydrocarbons from the subterranean hydrocarbon-bearing geological formation at a second production rate that is greater than the first production rate. The surfactant fluid does not form a scale or precipitate after 24 hours (h) exposure to the subterranean hydrocarbon-bearing geological formation at a temperature of 70° C. or greater. In some embodiments, the temperature of the subterranean hydrocarbon-bearing geological formation is at least 75° C., preferably at least 80° C., preferably at least 85° C., preferably at least 90° C., preferably at least 95° C., and preferably at least 100° C.

At step 56, the method 50 optionally includes circulating the surfactant solution in the borehole at a temperature of 65 to 75° C., preferably 66 to 74° C., preferably 67 to 73° C., preferably 68 to 72° C., more preferably 69 to 71° C., and yet more preferably about 70° C. In other embodiments, the circulating occurs at a temperature of 20 to 30° C., preferably 21 to 29° C., preferably 22 to 28° C., preferably 23 to 27° C., more preferably 24 to 26° C., and yet more preferably about 25° C. In some embodiments, circulating the surfactant solution in the borehole is done using continuous flow, ensuring steady interaction between the surfactant solution and the subterranean hydrocarbon-bearing geological formation. In some embodiments, the circulation may occur in a pulsed or intermittent flow pattern, allowing the surfactant solution to dwell periodically before being circulated again, improving contact time with the subterranean hydrocarbon-bearing geological formation. In some embodiments, the surfactant solution is circulated using a counter current flow method, where the flow is opposite to the natural fluid flow in the borehole, enhancing sweeping efficiency. In some embodiments, the surfactant is injected in phases at varying flow rates to improve oil displacement and reduce breakthrough. In yet another embodiment, co-current flow is used, where the surfactant solution flows in the same direction as natural fluid flow, maximizing sweep efficiency.

In some embodiments, before the injecting, the method includes mixing the surfactant fluid for 2 to 30 minutes (min), preferably 5 to 25 min, preferably 10 to 20 min, and preferably about 15 min. In some embodiments, the mixing can be performed using a high-speed mixer, mechanical stirrer, rotor-stator homogenizer, planetary mixer, ultrasonic agitator, jet mixer, a combination thereof, and the like to achieve uniformity. In some embodiments, the mixing can be done by stirring, swirling, sonicating, a combination thereof, and the like. The surfactant fluid is mixed to promote homogeneity and facilitate effective interactions among the various constituents. In some embodiments, the method includes settling the surfactant fluid for 6 to 12 hours (h), preferably 7 to 11 h, preferably 8 to 10 h, and preferably about 9 hours. The surfactant fluid may be settled for enhanced dispersion. Settling of the surfactant fluid enables the effective removal of suspended particles or impurities to improve the surfactant fluid uniformity and stability. In some embodiments, the method includes stirring the surfactant fluid for 30 to 90 min, preferably 35 to 85 min, preferably 40 to 80 min, preferably 45 to 75 min, preferably 50 to 70 min, more preferably 55 to 65 min, and yet more preferably about 60 min. Stirring prevents phase separation, ensures the even distribution of the components, and promotes enhanced interaction between the surfactant and the brine solution. Stirring also aids in breaking up any aggregates or clumps of particles that may have formed, ensuring the solution remains homogenous and stable. In some embodiments, the method includes sonicating the surfactant fluid for 20 to 60 min, preferably 25 to 55 min, preferably 30 to 50 min, more preferably 35 to 45 min, and yet more preferably about 40 min before the injecting. As used herein, the term “sonication” refers to the process in which sound waves are used to agitate particles in a solution. In some embodiments, other modes of agitation known to those of ordinary skill in the art, for example, via stirring, swirling, mixing, a combination thereof, and the like, may be employed to form the resultant mixture.

In some embodiments, the surfactant fluid has a zeta potential of −30 to −25 millivolts (mV), preferably −29 to −27 mV, more preferably −28.5 to −28 mV, and yet more preferably about −28.09 mV. In some embodiments, the surfactant fluid has an electrophoretic mobility of −2 to −2.4 micrometer centimeter per volt second (μm·cm/Vs), preferably −2.05 to −2.35 μm·cm/Vs, preferably −2.1 to −2.3 μm·cm/Vs, more preferably −2.15 to −2.2 μm·cm/Vs, and yet more preferably about −2.189 μm·cm/Vs. In some embodiments, the surfactant fluid has a conductivity of 69 to 70 millisiemens per centimeter (mS/cm), preferably 69.1 to 69.9 mS/cm, preferably 69.2 to 69.8 mS/cm, preferably 69.3 to 69.7 mS/cm, more preferably 69.4 to 69.6 mS/cm, and yet more preferably about 69.55 mS/cm.

In some embodiments, a rate of recovering one or more hydrocarbons from the subterranean hydrocarbon-bearing geological formation with the surfactant fluid is greater than a rate of recovering one or more hydrocarbons from the subterranean hydrocarbon-bearing geological formation with water. The silica nanoparticles enhance the stability and dispersion of the surfactant (i.e., SDS) in high-salinity and high-temperature environments. This results in better wettability alteration, reduced interfacial tension between oil and water, and increased electrostatic repulsion among surfactant molecules, which helps to prevent precipitation and scaling. With the addition of the SiO₂ NPs, the surfactant molecules are more evenly dispersed, improving their effectiveness in reducing the viscosity of the oil and enhancing oil displacement from the reservoir rock. In contrast, water alone lacks the ability to reduce the oil's surface tension or improve its mobility, especially in challenging conditions such as high salinity. The surfactant solution, especially one stabilized by nanoparticles, can more effectively mobilize trapped oil, leading to a higher rate of hydrocarbon recovery compared to using water alone.

### EXAMPLES

The following examples describe and demonstrate a method of enhanced oil recovery (EOR) in a subterranean geologic formation. The examples are provided solely for illustration and are not to be construed as limitations of the present disclosure, as many variations are possible without departing from the spirit and scope of the present disclosure.

### Example 1: Material and Methods

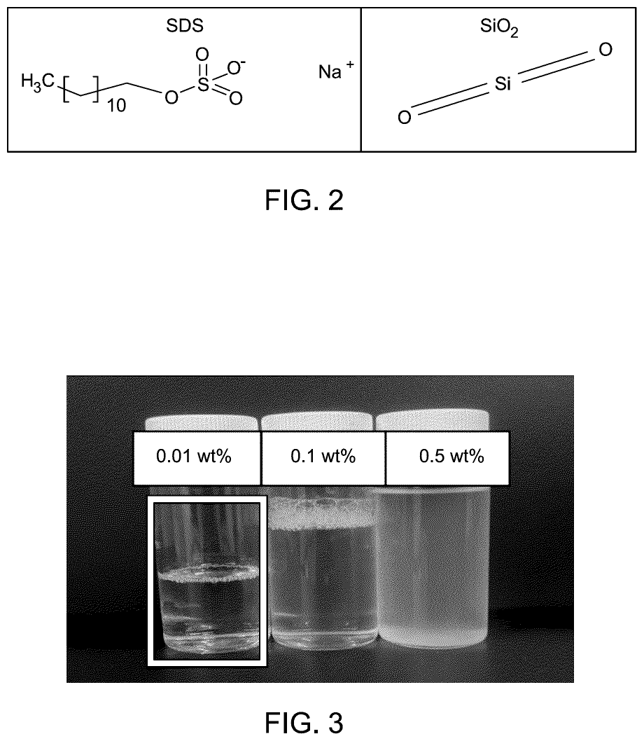

Sodium dodecyl sulfate (SDS), an anionic surfactant with a molecular weight of 288.38 grams per mole (g/mol) and a hydrophilic-lipophilic balance (HLB) of 40, was obtained from Sigma-Aldrich and used at a 0.25 weight percent (wt. %) concentration. Silicon dioxide (SiO₂) nanoparticles (NPs) was sourced from Sigma-Aldrich in nanopowder form. The SiO₂ NPs had a size range of 10 to 20 nanometers (nm), measured by a Brunauer-Emmett-Teller (BET) method, a molecular weight of 60.08 grams per mole (g/mol), a 99.5% trace metals basis, and a density of 2.2 to 2.6 grams per milliliter (g/mL) at 25 degrees Celsius (° C.), and were used at a 0.01 wt. % concentration. FIG. 2 depicts the chemical structures of SDS and SiO₂ NPs.

A surfactant solution was prepared by mixing 0.5 wt. % SDS in brine with a 57,000 parts per million (ppm) salt concentration, as listed in Table 1. The mixture was left overnight for enhanced dispersion. The SDS solution was then diluted to 0.25 wt. %, and 0.01 wt. % SiO₂ NPs were added while stirring. The final solution was stirred for one hour and sonicated for 40 minutes (min) at 80 kilohertz (kHz) under room conditions.

TABLE 1
Arabian gulf seawater salt composition

| Salt | Concentration (ppm) |
|---|---|
| Sodium bicarbonate (NaHCO₃) | 165.24 |
| Sodium sulfate (Na₂SO₄) | 6339.02 |
| Sodium chloride (NaCl) | 41172.35 |
| Calcium chloride (CaCl₂•2H₂O) | 1802.12 |
| Magnesium chloride (MgCl₂•6H₂O) | 8266.3 |
| Total dissolved solids (TDS) | 57745.08 |

Various experimental techniques were used to assess stability of formulations of SiO₂ NPs in deionized water (DIW), SiO₂ NPs in seawater (SW), and SiO₂ NPs in seawater with SDS. Further, SDS without SiO₂ NPs in seawater was also prepared to compare its performance with the proposed formulation. The tested formulations and the concentration of each solution are listed in Table 2.

TABLE 2
Prepared formulations in the present disclosure

| | SDS | SiO₂ | Volume |
|---|---|---|---|
| Solution | concentration | concentration | (mL) |
| SDS in SW + SiO₂ NPs | 0.25 wt. % | 0.01 wt. % | 25 |
| SDS in SW | 0.25 wt. % | — | 25 |
| SW + SiO₂ NPs | — | 0.01 wt. % | 25 |
| DIW + SiO₂ NPs | — | 0.01 wt. % | 25 |

Stability assessments of the formulations involved visual tests conducted at room temperature and 70° C., turbidity tests conducted at 70° C. for solutions including SiO₂ NPs, zeta potential (ZP) measurements, and hydrodynamic diameter (HDD) analysis. These methods compared the stability of the formulations of the current disclosure with other formulations.

The analysis began with visual observations to monitor solution stability. Two groups of formulations were prepared and one was stored at room temperature and the other was left in an oven at 70° C. The formulations were left for seven days and recorded over time to assess any observable changes.

Following the primary visual assessments of stability over time, more robust techniques were employed to comprehensively examine the solutions' stability. The second phase involved turbidity tests to assess particle settling by measuring sample transmission. Turbidity tests were conducted by placing a sample including SiO₂ NPs in a vial within a tower that continuously emits light onto the sample. The light transmission was measured to determine nanoparticle dispersion and stability.

Turbidity tests were conducted for a full day on samples including SiO₂ NPs at 70° C. to evaluate the stability of the formulations compared to other formulations. These tests were performed using a MultiScan MS 20 purchased from DataPhysics to ensure accuracy and reliability in assessing particle settling or aggregation.

Zeta potential (ZP) measurements were used for assessing solution stability. These measurements were performed by filling a specialized vial with the liquid of interest and placing it inside the analyzer. The analyzer then applied an electric field, causing the particles to move in response to the interaction between their surface charges and the field. This interaction was used to determine the absolute value of the ZP.

ZP measurements provide insights into electrostatic repulsions between the formulations, serving as an indicator of solution stability, where higher absolute ZP values indicate better stability than solutions with lower absolute ZP values [Almahfood, M. et al., The synergistic effects of nanoparticle-surfactant nanofluids in EOR applications, J Pet Sci Eng, 2018, 171, 196-210, which is incorporated herein by reference in its entirety]. These measurements were conducted over seven days, with each test including 100 runs and five repetitions. To minimize errors, an average curve was generated for each day.

Following ZP measurements, hydrodynamic diameter (HDD) measurements were conducted to provide insights into particle aggregation. These measurements were performed using the same equipment as the ZP measurements. The HDD measurements determine particle size by measuring random changes in the intensity of light scattered from a suspension or solution. Based on these changes, the machine calculates the average HDD of the solution. The procedure involved three runs per day, with five repetitions, and an average curve was derived each day for seven days. ZP and HDD measurements were performed using the LiteSizer DLS 100, purchased from Anton Paar.

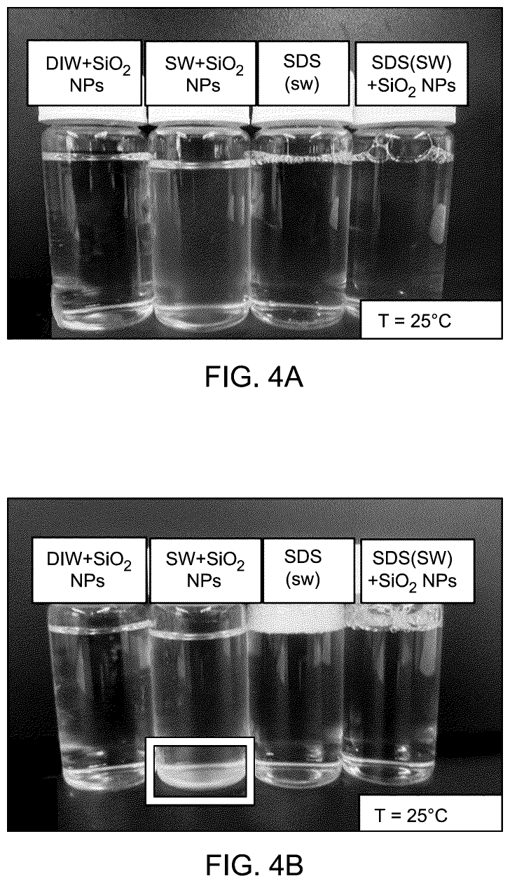

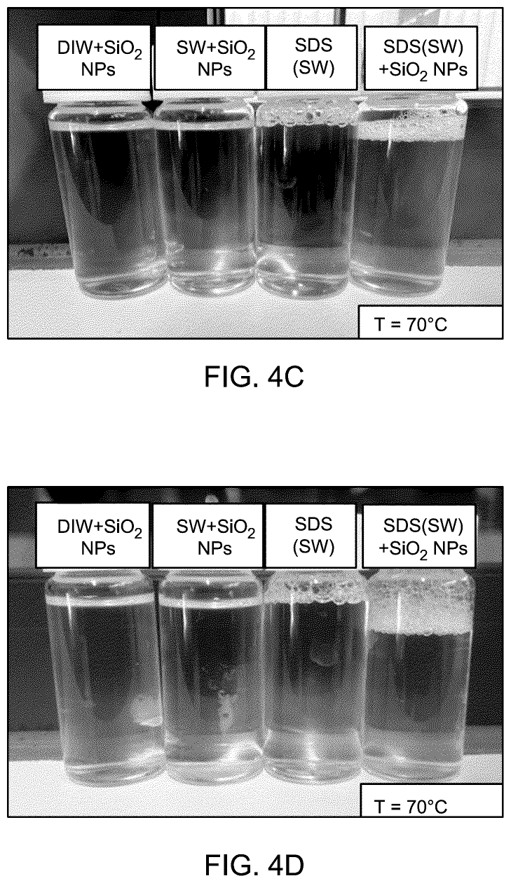

Table 2 lists visual test results of formulations of the present disclosure. Multiple SiO₂ nanoparticle concentrations were tested before proceeding with other evaluations, as shown in FIG. 3. A concentration of 0.01 wt. % was determined for dispersing SiO₂ NPs and preventing SDS precipitation in a solution. Lower SiO₂ NP concentrations were more effective and easier to disperse than higher concentrations and have been used in other analyses [Hendraningrat, L. et al., Metal oxide-based nanoparticles: revealing their potential to enhance oil recovery in different wettability systems, Appl Nanosci, 2015, 5, 181-199, which is incorporated herein by reference in its entirety]. At lower concentrations, fewer particles reduce the likelihood of collisions and aggregation. Conversely, higher concentrations of SiO₂ NPs increase the frequency of collisions, leading to greater aggregation [Holthoff, H. et al., Coagulation rate measurements of colloidal particles by simultaneous static and dynamic light scattering, Langmuir, 1996, 12, 23, 5541-5549, which is incorporated herein by reference in its entirety]. SDS exhibits precipitation in high-salinity environments due to the presence of numerous ions, especially positive ions such as Na⁺ [Li, P. et al., Multivalent electrolyte induced surface ordering and solution self-assembly in anionic surfactant mixtures: Sodium dodecyl sulfate and sodium diethylene glycol monododecyl sulfate, J Colloid Interface Sci., 2020, 565, 567-581, which is incorporated herein by reference in its entirety]. These ions reduce the electrostatic repulsion between the negatively charged SDS molecules, increasing their aggregation and precipitation. High salt concentrations increase ionic strength of a solution, resulting in a “salting out” effect. FIGS. 4A-4B depict formulations on day one and day seven at 25° C., respectively. FIGS. 4C-4D depict formulations on day one and day seven at 70° C., respectively. The salting out effect decreases the solubility of SDS as the added ions compete with SDS molecules for water. The salting out effect makes it difficult for SDS to remain dissolved and demonstrates SDS's intolerance to high salinities and poor aqueous stability; however, adding SiO₂ NPs improves SDS stability and prevents precipitation. SiO₂ NPs enhance SDS aqueous stability in high-salinity environments through several mechanisms. SiO₂ NPs provide steric stabilization by creating a physical barrier around SDS molecules, preventing aggregation and precipitation. SiO₂ NPs also enhance electrostatic repulsion between SDS molecules, further reducing the likelihood of aggregation. This effect appeared when comparing SDS alone with SiO₂ nanoparticles on a closer scale at a temperature of 25° C. and 70° C., as shown in FIGS. 4A-4D.

FIGS. 4A-4B depict formulations on day one and day seven at 25° C., respectively. FIGS. 4C-4D depict formulations on day one and day seven at 70° C. The observed precipitation behavior might be attributed to the Krafft temperature, indicating that the solution remained below the Krafft point, preventing micelle formation. “Krafft temperature,” or Krafft point, refers to the minimum temperature required for surfactant molecules to form micelles. Below this point, surfactants exhibit reduced solubility and tend to crystallize or precipitate. For SDS, the Krafft temperature in DIW was found to be around 14° C. at a concentration of approximately 7000 ppm [Vautier-Giongo, C. and Bales, B. L., Estimate of the ionization degree of ionic micelles based on Krafft temperature measurements, J Phys Chem B, 2003, 107, 5398-5403, which is incorporated herein by reference in its entirety]. The Krafft temperature decreases as SDS concentration decreases. Above a temperature of 14° C., micellar aggregates form, preventing crystallization. Increasing salt concentration raises the Krafft temperature of SDS and reduces its solubility in water.

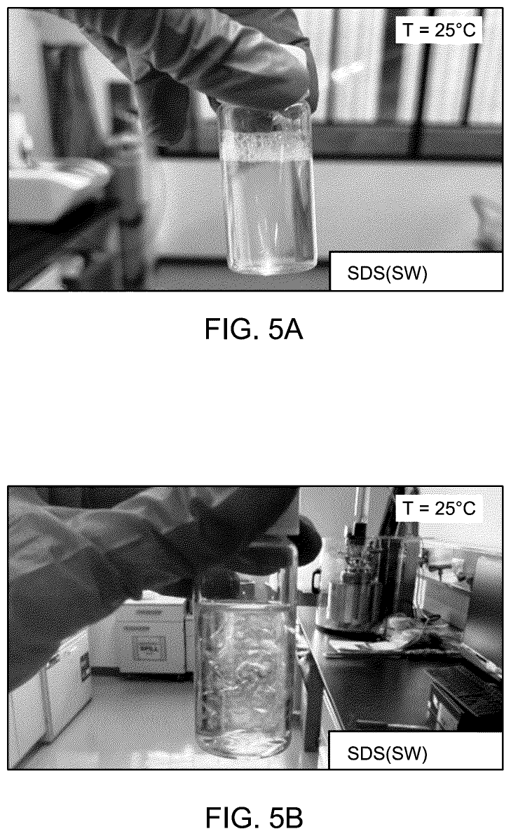

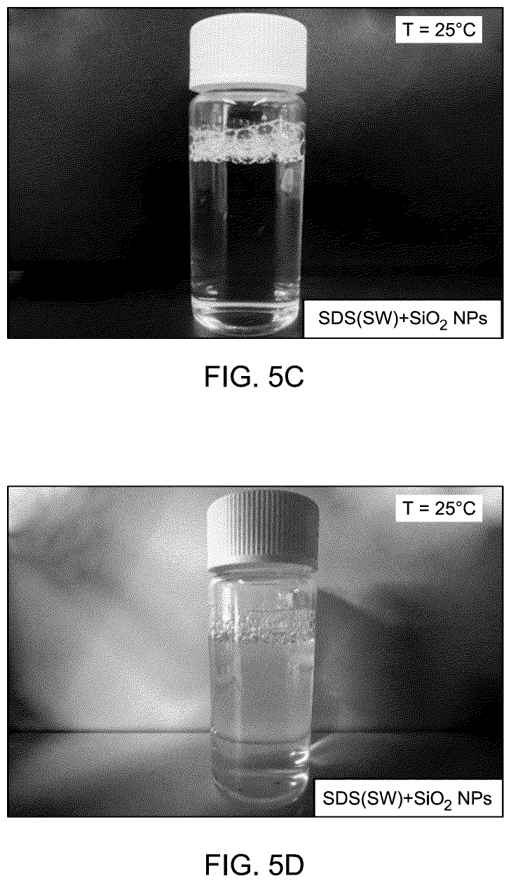

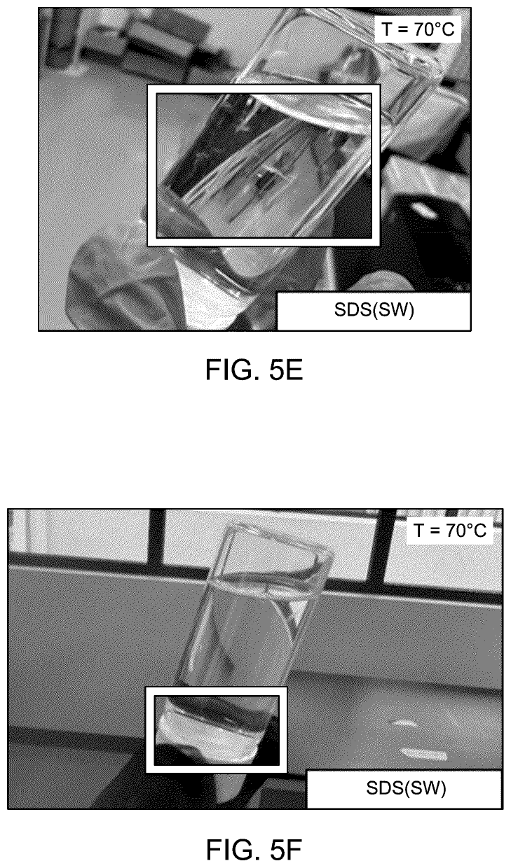

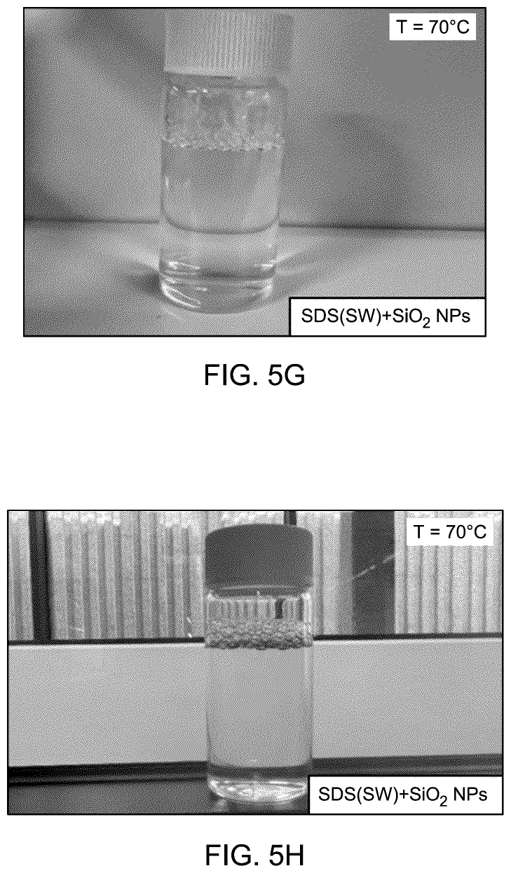

Since the experiments were conducted at 25° C., the Krafft temperature may be responsible for the precipitation observed; however, no data were available on the Krafft temperature for the specific salinity and salt composition used in the present disclosure. Though the Krafft temperature may increase with salt concentration, it is unlikely to reach 25° C. under the tested conditions, as shown in FIGS. 4A-4D. A modest increase in Krafft temperature has been observed with higher salt concentrations. FIGS. 5A-5B depict SDS in seawater on day one and day seven at 25° C., respectively. FIGS. 5C-5D depict SDS in seawater with SiO₂ nanoparticles on day one and day seven at 25° C., respectively. FIGS. 5E-5F depict SDS in seawater on day one and day seven at 70° C., respectively. FIGS. 5G-5H depict SDS in seawater with SiO₂ nanoparticles on day one and day seven at 70° C., respectively. The presence of precipitates at 70° C. were above the Krafft point, suggesting that the Krafft temperature was not a large factor in the precipitation, as shown in FIGS. 5E-5H. Instead, the high ionic strength of the solution due to the presence of divalent ions in the complex seawater (SW) solution may be a factor in precipitation as it weakens the electrostatic repulsion between SDS molecules. While the Krafft temperature may have contributed to precipitation at 25° C., it was not a primary mechanism.

Turbidity tests were conducted to determine outcomes from visual observation regarding formulation stability. The turbidity scanning method detected agglomeration and sedimentation processes and quantified nanoparticle stability levels. The machine generated a transmission profile indicating sample stability, as transmission depends on sample transparency.

The transmission profile remained consistent with dispersed and stable SiO₂ NPs. Transmission profiles exhibit greater variations with unstable NPs or molecules prone to aggregation and precipitation, which is indicated by a large difference between initial and final readings. The difference that arose from increased transmission during precipitation events as aggregated particles settled and enhanced sample transparency. Light may penetrate solutions more effectively, leading to a higher transmission compared to an initial state where NPs or molecules are uniformly dispersed and obstruct the passage of light.

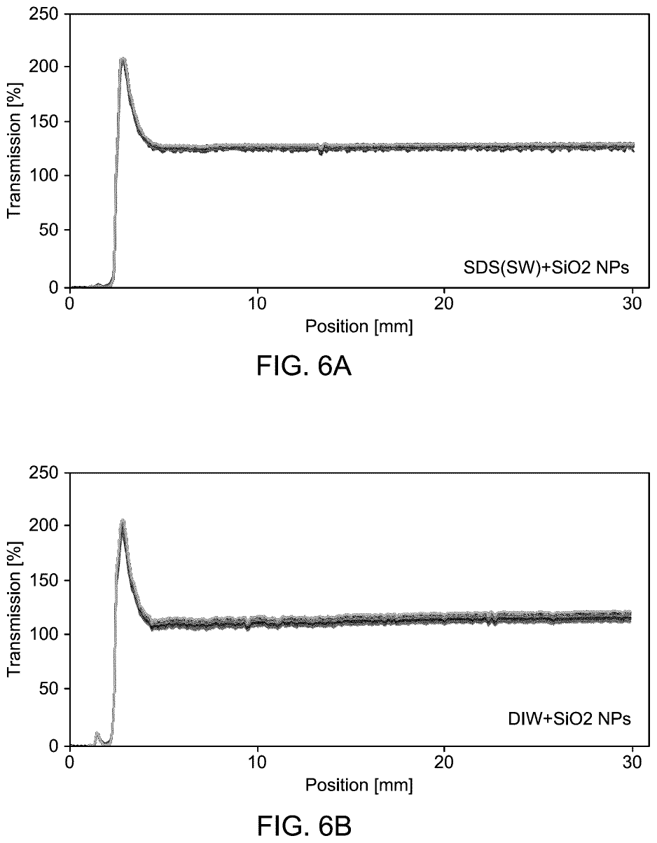

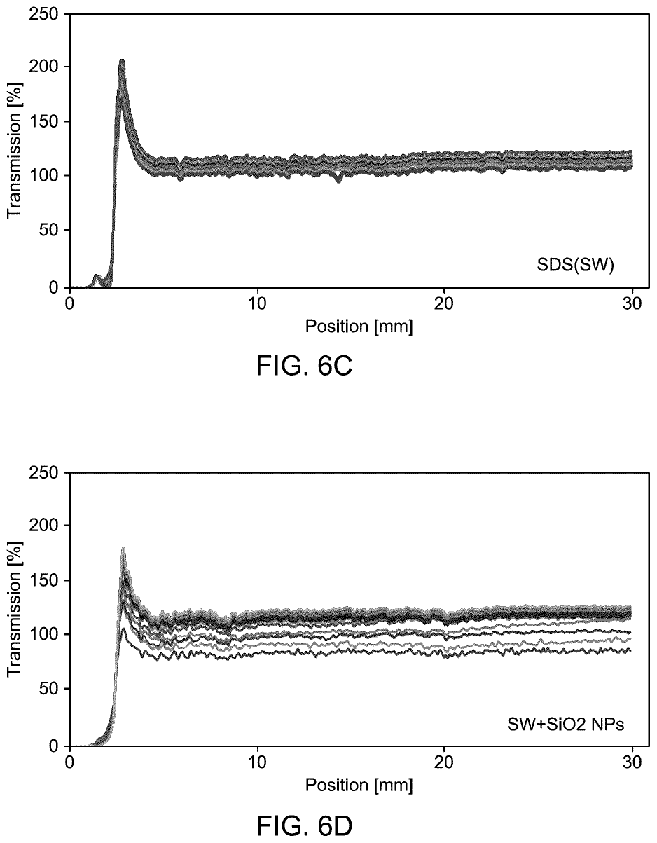

FIGS. 6A-6D depict trends in transmission profiles of SiO₂ NPs with different base fluids (deionized water (DIW), seawater (SW), and SDS in SW) and SDS in SW without SiO₂ NPs. In DIW, a slight increase in transmission was observed, indicating some settling of NPs, which allows light to pass through more easily, thereby increasing transmission. Conversely, SiO₂ NPs in SW exhibited instability, primarily due to interactions between the SiO₂ NPs and salt molecules. This instability was further exacerbated with SDS, which showed an even more unstable profile compared to SiO₂ NPs in SW and SiO₂ NPs in DIW. This behavior was attributed to precipitation of SDS molecules caused by their instability in harsh salt conditions.

An increase in transmission suggests nanoparticle aggregation and SDS precipitation, highlighting the limitations of using SiO₂ NPs alone and SDS alone in high-salinity base fluids. While SDS in SW is unstable, turbidity measurements taken on day one show less precipitation compared to what was observed on day seven, however, on day one the formulations showed greater stability. The SDS in SW+SiO₂ NPs formulation emerged as the most stable sample, displaying minimal changes in transmission. This minimal change indicated little settling over 24 hours (h), underscoring the formulation's efficacy in maintaining nanoparticle dispersion and simultaneously preventing aggregation and precipitation of SDS molecules. This outcome highlights enhancement of aqueous stability of the anionic surfactant SDS with SiO₂ NPs in high-salinity conditions.

TABLE 3
Separation rate equations for each solution

| Sample | Rate |
|---|---|
| SDS in SW + SiO₂ NPs | $\frac{0.03556 + 0.0004543}{h}$ |
| DIW + SiO₂ NPs | $\frac{0.1066 + 0.002336}{h}$ |
| SDS in SW | $\frac{0.291 + 0.006631}{h}$ |
| SW + SiO₂ NPs | $\frac{0.6166 + 0.02233}{h}$ |

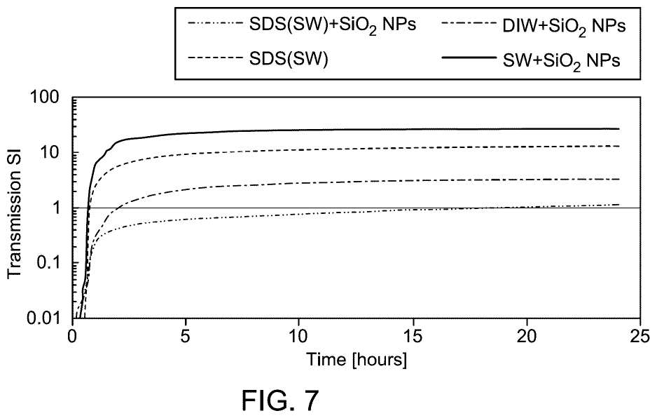

A stability hierarchy among the formulations becomes evident, as seen in FIG. 7, which depicts the transmission separation index (TSI), indicating how the solution separates over time and its stability. The sample with the lowest TSI values over time is the most stable and shows the fewest signs of separation. The SDS in SW+SiO₂ NPs formulation exhibits the highest stability, characterized by its minimal TSI. SiO₂ nanoparticles (NPs) in DIW rank second in terms of TSI, followed by SDS in SW, which displays a less stable transmission profile than the first two. SiO₂ NPs in SW are the most unstable, highlighting the effectiveness of the SDS in SW+SiO₂ NPs formulation in simultaneously enhancing both the aqueous stability of SDS and the stability and dispersibility of SiO₂ NPs under challenging salinity conditions.

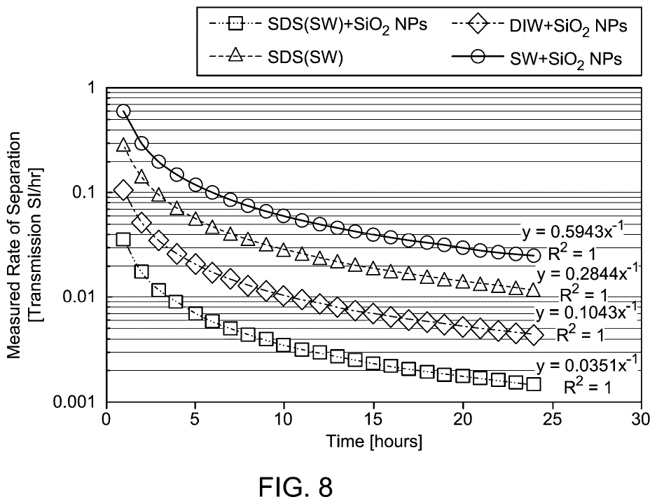

Table 3 depicts the separation rate equations derived from FIG. 7 for each formulation. The separation rate was inversely related to stability, meaning the lowest separation rate corresponded to the highest stability. Each measurement was conducted over a 24-hour period and equations were generated to predict the separation rate for each sample (formulation). The separation rate over time for the samples and the predicted separation rate equations generated by fitting data is shown in FIG. 8. The obtained predictions underscore the enhanced performance of the SDS in SW+SiO₂ NPs formulation in maintaining nanoparticle dispersion and preventing aggregation and precipitation in high-salinity conditions.

TABLE 4
Prediction equations generated from fitting the data using power trendline

| Sample | Prediction Equation |
|---|---|
| SDS in SW + SiO₂ NPs | $\frac{0.0351}{t}$ |
| DIW + SiO₂ NPs | $\frac{0.1043}{t}$ |
| SDS in SW | $\frac{0.2844}{t}$ |
| SW + SiO₂ NPs | $\frac{0.5943}{t}$ |

The separation rate of each formulation was determined using the equations listed in Table 4 and shown in FIG. 8. The initial separation rates for SDS in SW, SiO₂ NPs in DIW, and SiO₂ NPs in SW were higher than those of the SDS in SW+SiO₂ NPs formulation. This shows that many particles in the SDS in SW, SiO₂ NPs in DIW, and SiO₂ NPs in SW formulations separated from the base fluid, causing aggregation and precipitation. SDS in SW depicts that surfactant molecules crystallized and precipitated due to the strong ionic strength, reducing SDS solubility. These outcomes support the visual observations and, since the test was conducted at 70° C., indicate that SDS precipitation results from ionic strength rather than the Krafft temperature.

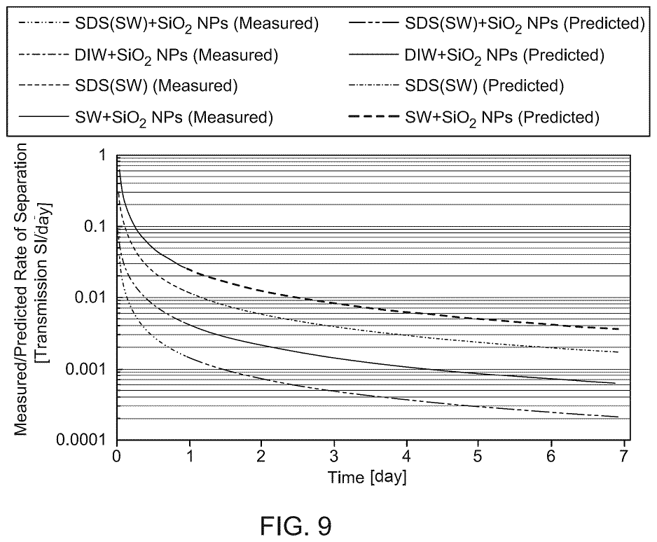

The measurements were conducted over a single day for each sample. Fitting the separation rate over time generated predictive equations, as shown in Table 4, which depict the separation rate over seven days. The measured separation profiles were then plotted alongside the predicted profiles to provide a more comprehensive understanding of the formulations' performance over a week, which is shown in FIG. 9. This approach offers insights into long-term stability and efficacy of the formulations in maintaining a nanoparticle dispersion and preventing aggregation and precipitation in high-salinity conditions.

FIG. 9 depicts predicted rate of separation versus time for seven days. The comparison between the measured and predicted profiles (FIG. 9) confirmed that the SDS in SW+SiO₂ NPs formulation exhibited the lowest separation rate at 70° C. This indicates increased stability and dispersibility compared to other formulations, including SiO₂ NPs in DIW, which has been extensively used and was presumed to be efficient. The SDS in SW+SiO₂ NPs formulation surpassed the SiO₂ NPs in DIW benchmark, highlighting enhanced performance. In addition to the transmission and separation rate profiles, another parameter is the separability number, which quantifies a formulation's tendency to separate.

Although SDS in SW initially showed great stability from visual observation on day seven compared to SiO₂ NPs in SW, the prediction curve shows it as more stable than SiO₂ NPs in SW after a week. This is because the prediction was based on the data collected on day one. The precipitation phenomenon of SDS was complex and non-linear, which explains why observed precipitation was higher on day seven despite initial turbidity measurements indicating a more stable profile than SiO₂ NPs in SW. The complexity and non-linearity of SDS precipitation in SW contributes to more stable TSI profiles initially, but not over extended periods.

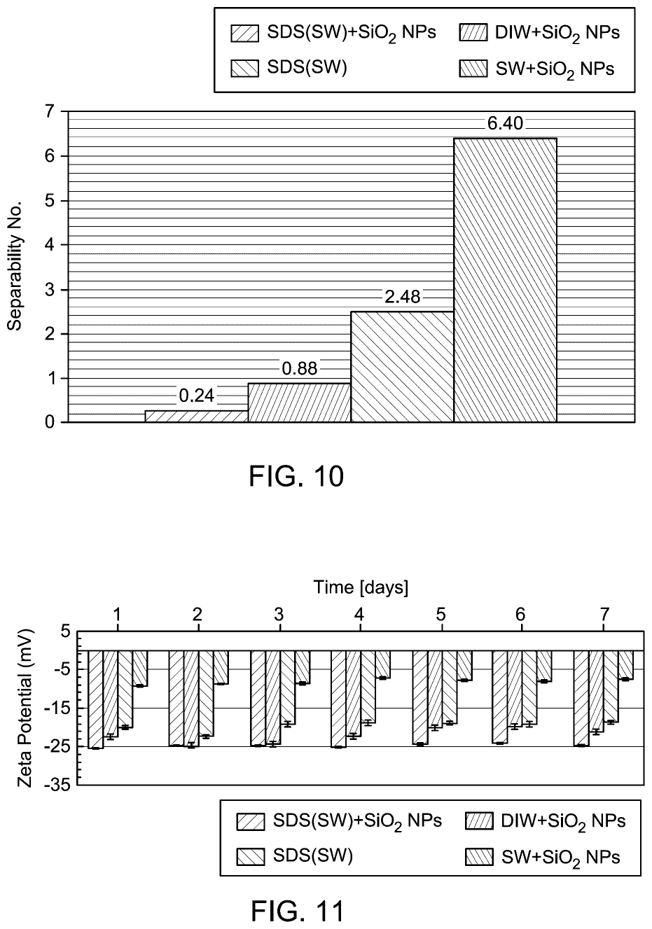

Higher separability numbers indicate unstable and incompatible solutions, where separation occurs more rapidly than in stable solutions. As shown in FIG. 10, the difference in separability numbers highlights the performance of the SDS in SW+SiO₂ NPs formulation, which exhibited an exceptionally low value. In contrast, the other two solutions including SiO₂ NPs in SW and SDS in SW demonstrate relatively higher values. This disparity may be attributed to the enhanced dispersion of SiO₂ NPs facilitated by the SDS in SW+SiO₂ NPs formulation and the prevention of SDS precipitation. The combined advantages of the SDS in SW+SiO₂ NPs formulation in both aspects contribute to its low separability number, further validating its efficacy and potential in practical applications.

Zeta potential (ZP) measurements were used to assess the solutions' stability, as listed in Table 5. ZP may be positive or negative and was used in determining the stability of nanofluids, colloidal systems, and surfactants. A high absolute ZP value indicates a more stable and dispersed nanofluid. A low absolute value of ZP signals a greater chance of the particles settling, aggregating, and/or precipitation of molecules.

TABLE 5
Results from zeta potential measurement

| Sample | SDS + SiO₂ | SDS |
|---|---|---|
| Mean zeta potential (mV) | −28.09285721 | −21.33917889 |
| Standard deviation (mv) | 1.502588543 | 1.725079003 |
| Electrophoretic mobility (μm · cm/Vs) | −2.189494394 | −1.663127826 |
| Conductivity (mS/cm) | 69.55173301 | 70.76505776 |
| Distribution peak (mv) | −4.781350802 | −4.64236818 |
| Processed runs | 100 | 100 |

ZP profiles for the samples for seven days are shown in FIG. 11. Starting with the base case of DIW and SiO₂ NPs, a relatively stable solution was observed, as indicated by the absolute value of its ZP (ζ=22.49 mV), attributed to the absence of salts, which did not cause any reductions in the overall charge due to ion exchanges when divalent ions were present. When different salts were added to the mix, the absolute value of ZP decreases due to the suppression of the electric double layer around the SiO₂ NPs. This, coupled with a reduction in particle surface charge, causes the silica particles to clump together. This trend was evident in the second case, where SiO₂ NPs were introduced into SW, resulting in a decrease in the absolute value of ZP from (ζ=22.49 mV to ζ=9.27 mV), demonstrating the impact of the complex salt system.

Introduction of SDS to SW resulted in a higher absolute value of ZP (ζ=20.12 mV) compared to the case of SW+SiO₂ NPs; however, SDS tends to precipitate over time due to its intolerance to high salinities. When SiO₂ NPs were added to SDS in SW, there was a subsequent increase in the absolute value of ZP (ζ=25.55 mV). This was attributed to enhanced repulsions between the negatively charged SiO₂ NPs and SDS molecules with a negative head group. This demonstrates that the SDS in SW+SiO₂ NPs formulation was more electrostatically stable than SDS in SW. This supports that there were enhanced electrostatic repulsions that caused the overall mixture to be more stable and eliminated the possibility of precipitation. The magnitude of ZP predicts colloidal stability with NPs having values >+25 mV or <−25 mV indicating a high degree of stability. The higher the difference between initial and final ZP values, the more degradation occurred with time; however, when these variations were minimal and may be attributed to equipment-related factors, the sample was stable over time.

SiO₂ NPs form fractal aggregates when the electrical double layer collapses at high salt concentrations, reducing stabilizing forces. Accurate high-definition distribution (HDD measurements were used in nanotechnology, especially in EOR, where SiO₂ NP aggregation poses a concern. As NP concentrations increase, collisions between particles may increase the potential for aggregations. Thus, HDD measurements were considered to check the effectiveness of the formulations and whether there was any aggregation. Furthermore, comparing the formulations with surfactant-free solutions was done in consideration of the widespread use of SiO₂ in DIW, which has been used before in oil recovery.

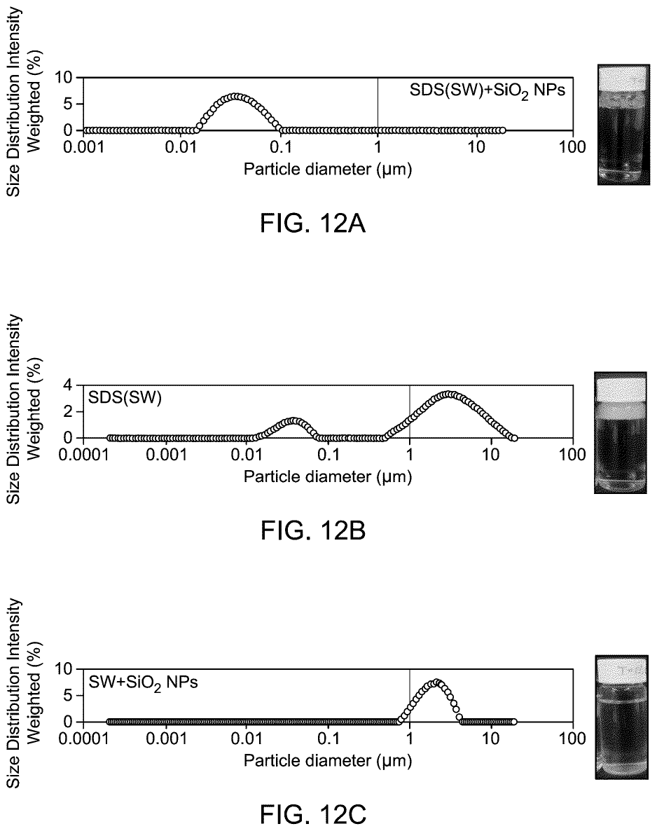

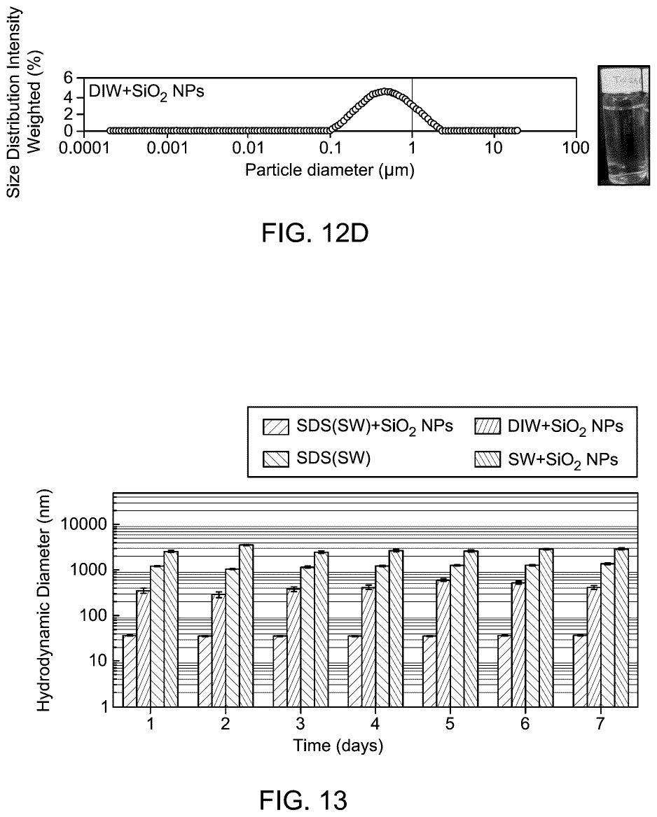

FIGS. 12A-12D exhibit the initial HDD values and standard deviations for the formulations. Using SiO₂ NPs sized between 10 to 20 nm in the base fluid (DIW) resulted in a relatively small to medium particle aggregation, which was 350 nm with a uniform distribution (FIG. 12D). Conversely, when SW was the base fluid, a substantial aggregation occurred, measuring an HDD of 2570 nm (FIG. 12B). This affirms the complexity introduced by higher salinity base fluids, increasing the possibility of severe aggregations due to attractive forces between NPs and salt molecules.

An observation in the third case (FIG. 12C) involving SDS revealed two distinct distributions. This phenomenon stemmed from SDS's intolerance to high salinity, which resulted in precipitation. Two distributions were attributed to some SDS molecules precipitating while others remained dispersed. This occurrence was initially detected as the only solution to form precipitates. An HDD of 1230 nm was also observed, which was attributed to the aggregation of oppositely charged particles. The SDS in SW+SiO₂ NPs sample exhibited a smaller HDD of 37 nm (FIG. 12A).

This emphasizes the accuracy of the selected concentration in the present disclosure. Additionally, it highlights the efficacy of incorporating SDS to stabilize SiO₂ NPs in high-salinity solutions, showcasing a difference compared to SiO₂ NPs in SW. The NPs contributed to enhancing the aqueous stability of SDS, as evidenced by the absence of visual aggregation or precipitation and further confirmed by HDD measurements.

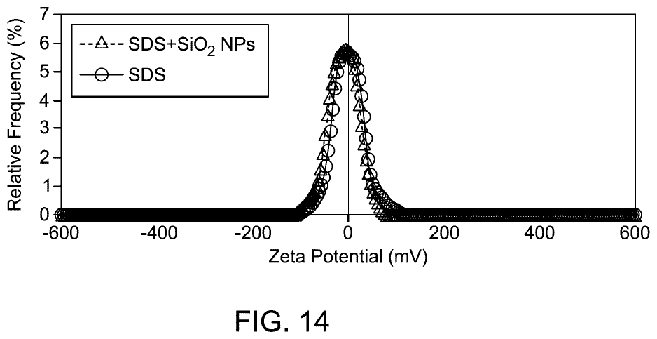

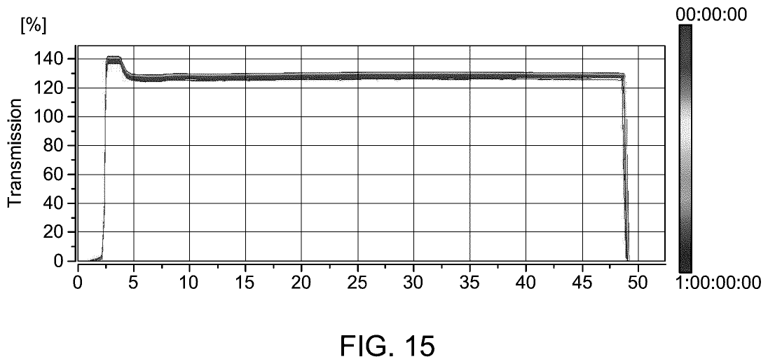

Observations of daily recordings of HDD values over seven days are shown in FIG. 13. Profiles exhibited minimal HDD variation, which may be attributed to inherent equipment uncertainties, the SDS in SW+SiO₂ NPs formulation showed good stability through the seven-day duration, providing evidence that the formulation effectively prevents aggregation within the specific timeframe of this experiment. FIG. 14 shows plot for zeta potential measurement for SDS in SW+SiO₂ NPs formulation and SDS in SW. FIG. 15 depicts the transmission profile of SDS in SW with SiO₂ NPs from a turbidity test.

Aspects of the present disclosure provide an improvement using nanoparticles to enhance the stability of anionic surfactants in EOR and other oil and gas operations under harsh conditions. The process involves formulating a nanofluid solution with a 0.01 wt. % concentration of SiO₂ NPs and SDS in a seawater brine composition. Levels of SiO₂ nanoparticles enhance aqueous stability and thermal stability of anionic surfactants like SDS in seawater brine, which is used in EOR, fracturing fluids, and other oil and gas operations. The SDS in SW+SiO₂ NPs formulation exhibited better stability than SDS alone in high-salinity seawater brine, remaining free from precipitation or scaling for an extended period. A higher zeta potential value was observed in the SDS in SW+SiO₂ NPs formulation, indicating increased electrostatic repulsion between surfactant molecules and the negatively charged SiO₂ NPs, which made it more effective for EOR applications. Turbidity tests confirmed that the nanoparticles remained well-dispersed without precipitating, even in high-salinity solutions with complex salt compositions. The synergy between the surfactant (i.e., SDS) and nanoparticles (i.e., SiO₂ NPs) improved oil recovery, offering an economical and environmentally sustainable method for EOR. This approach enhanced efficiency in high-salinity environments while reducing operational costs. The SDS in SW+SiO₂ NPs formulation addressed challenges of anionic surfactant precipitation and SiO₂ nanoparticle aggregation. It offered a solution for EOR under harsh conditions.

A method to improve the aqueous stability of anionic surfactants in harsh conditions using silica nanoparticles for EOR applications is described. Anionic surfactants are known to be unstable in high-salinity environments in EOR application and to cause severe scaling and precipitation. In the present disclosure, the aqueous stability of SDS, an anionic surfactant, was improved by varying concentrations of SiO₂ NPs in a sea brine with a salinity of 57,000 ppm, which represents a complex system of salt presents in Arabian Gulf seawater used as injection fluids for EOR. Adding SiO₂ NPs enhances the aqueous stability of SDS and prevents precipitation in injected sea brine. The solution's effectiveness was tested by ageing the samples at room temperature and 70° C., confirming the efficacy of the proposed solutions in avoiding precipitation. Solution stability was explored through various tests, including zeta potential, static bottle, and turbidity. Incorporating SiO₂ NPs enhances electrostatic repulsion among solution molecules. This is attributed to the negative charge of both SiO₂ NPs and SDS molecules, leading to improved nanoparticle dispersion in aqueous solutions. This creates a more stable formulation for EOR applications. Adding SiO₂ NPs to the SDS mixture is evidenced by increased dispersion and reduced settling in turbidity tests. This approach also enhances the long-term stability of the surfactant. A minimal nanoparticle concentration can bolster SDS's stability in high salinity and high temperature environments.

Numerous modifications and variations of the present disclosure are possible in light of the above teachings. Therefore, it is to be understood that within the scope of the appended claims, the disclosure may be practiced other than as specifically described herein.

1: A method of enhanced oil recovery (EOR), including:
injecting a surfactant fluid, through a borehole, into a subterranean hydrocarbon-bearing geological formation having a first production rate,
wherein the surfactant fluid includes sodium dodecyl sulfate (SDS) in an amount of 0.01 to 1.0 percent by weight (wt. %), silicon dioxide nanoparticles (SiO₂ NPs) in an amount of 0.005 to 0.4 wt. %, and a brine solution with a salt concentration of 55,000 to 60,000 parts per million (ppm),
wherein wt. % is based on a total weight of the surfactant fluid,
wherein the SiO₂ NPs have a longest dimension of 10 to 20 nanometers (nm),
wherein the brine solution includes sodium bicarbonate, sodium sulfate, sodium chloride, calcium chloride, and magnesium chloride, and then
recovering one or more hydrocarbons from the subterranean hydrocarbon-bearing geological formation at a second production rate that is greater than the first production rate,
wherein the surfactant fluid does not form a scale or precipitate after 24 hours (h) exposure to the subterranean hydrocarbon-bearing geological formation at a temperature of 70 degrees Celsius (° C.) or greater.

2: The method of claim 1, wherein the brine solution has a salt concentration of 56,000 to 58,000 ppm.

3: The method of claim 1, wherein the brine solution has a salt concentration of 57,700 to 57,800 ppm.

4: The method of claim 1, wherein the temperature of the subterranean hydrocarbon-bearing geological formation is at least 75° C.

5: The method of claim 1, wherein the surfactant fluid has a zeta potential of −30 to −25 millivolts (mV).

6: The method of claim 1, further including:
mixing the surfactant fluid for 2 to 30 minutes (min), then;
settling the surfactant fluid for 6 to 12 h, then;
stirring the surfactant fluid for 30 to 90 min, and then;
sonicating the surfactant fluid for 20 to 60 min before the injecting.

7: The method of claim 1, wherein the sodium bicarbonate has a concentration of 150 to 180 ppm in the brine solution.

8: The method of claim 1, wherein the sodium sulfate has a concentration of 6300 to 6380 ppm in the brine solution.

9: The method of claim 1, wherein the sodium chloride has a concentration of 41,100 to 41,300 ppm in the brine solution.

10: The method of claim 1, wherein the calcium chloride has a concentration of 1700 to 1900 ppm in the brine solution.

11: The method of claim 1, wherein the magnesium chloride has a concentration of 8200 to 8300 ppm in the brine solution.

12: The method of claim 1, wherein the SDS is present in an amount of 0.4 to 0.6 wt. % based on a total weight of the surfactant fluid.

13: The method of claim 1, wherein the SiO₂ NPs are present in an amount of 0.05 to 0.3 wt. % based on a total weight of the surfactant fluid.

13: The method of claim 1, wherein the SiO₂ NPs are present in an amount of 0.008 to 0.012 wt. % based on a total weight of the surfactant fluid.

14: The method of claim 1, further including:
circulating the surfactant solution in the borehole at a temperature of 65 to 75° C.

15: The method of claim 1, further including:
circulating the surfactant solution in the borehole at a temperature of 20 to 30° C.

16: The method of claim 1, wherein the surfactant fluid has an electrophoretic mobility of −2 to −2.4 micrometer centimeter per volt-second (μm·cm/Vs).

17: The method of claim 1, wherein the surfactant fluid has an electrophoretic mobility of −2.1 to −2.3 μm·cm/Vs.

18: The method of claim 1, wherein a rate of recovering one or more hydrocarbons from the subterranean hydrocarbon-bearing geological formation with the surfactant fluid is greater than a rate of recovering one or more hydrocarbons from the subterranean hydrocarbon-bearing geological formation with water.

19: The method of claim 1, wherein the surfactant fluid has a zeta potential of −29 to −27 mV.

20: The method of claim 1, wherein the surfactant fluid has a conductivity of 69 to 70 millisiemens per centimeter (mS/cm).
